(19) United States
(12) Patent Application Publication
(10) Pub. No.: US 2025/0132479 A1
(43) Pub. Date: Apr. 24, 2025

(54) ALTERNATING CURRENT APPARATUS

(71) Applicant: Laser Systems Inc., Tokushima (JP)

(72) Inventors: Yasuo OHNO, Tokushima (JP); Hiroko ITOH, Tokushima (JP)

(21) Appl. No.: 18/918,186

(22) Filed: Oct. 17, 2024

(30) Foreign Application Priority Data
Oct. 20, 2023 (JP) 2023-181151

(51) Int. Cl. H01P 1/18; H01Q 1/50; H01Q 9/04; H02M 7/06

(52) U.S. Cl. CPC H01P 1/182; H01Q 1/50; H01Q 9/0407; H02M 7/06

(57) ABSTRACT

A transmission line of an output impedance Z_{C} with one end point connected to an alternating current power source; a plurality of phase shifters connected to the other end point of the transmission line; and an alternating current circuit connected to each of the plurality of phase shifters, with a branch into a plurality of lines, each of which has a phase shifter placed before the alternating current circuit that serves as a load. Each of the plurality of phase shifters has a phase shift angle and a characteristic impedance with which a real part of a composite admittance as viewed from the other end point is 1/Z_{C} and an imaginary part is zero for a plurality of conditions of an input signal. This achieves impedance matching for signals of a plurality of frequencies and a plurality of powers.

### CROSS REFERENCE TO RELATED APPLICATIONS

The entire disclosure of Japanese Patent Application No. 2023-181151 filed on Oct. 20, 2023 is incorporated herein by reference in its entirety.

### TECHNICAL FIELD

The present disclosure relates to an alternating current apparatus.

### BACKGROUND ART

Microwave antennas efficiently transmit a signal to the air by performing impedance-match by adjusting the antenna size and the power supply position such that there is no reflection at a desired frequency and at the characteristic impedances of a signal source or a transmission line.

In addition, along with the prevalence of electric vehicles and portable devices, there is an increasing demand for non-contact power supply. The non-contact power supply using microwaves uses a rectenna circuit, which is a circuit that converts (rectifies) into DC the microwaves, which are AC.

In the rectenna circuit that converts an alternating current signal into a direct current signal, power reflection occurs between the signal source and the rectifier circuit. With an antenna that releases radio waves into the air, reflection occurs at the interface between the signal cable and the antenna. Reflected power is not only ineffectively used but also may destroy a power transmission apparatus (power source) if the reflected power returns to the power transmission apparatus.

Generally, in order to prevent reflection, a matching circuit is disposed between apparatuses where reflection is generated. It is known that when the output impedance of the power transmission apparatus side and the input impedance at the entrance of the matching circuit are in a complex conjugate relationship with the inserted matching circuit, it is possible to prevent reflection and supply the load with maximum power (see, for example, PTL 1). In other words, in order to supply the load with maximum power, it is necessary for the output impedance of the power source and the input impedance of the load to have the same real number value.

### CITATION LIST

### Patent Literature

### PTL 1

Japanese Patent No. 5953603

### SUMMARY OF INVENTION

In the rectenna circuit for rectifying a high frequency, the rectification diode used for rectification has a nonlinear characteristic with respect to input power. As a result, even in the case where the rectenna circuit is matched at a certain input power value, the input impedance changes as the input power value changes, which results in reflection loss. For this reason, the power range in which the rectenna circuit achieves high efficiency is narrow even when a matching circuit is used. In an environment where transmission conditions are unstable as in wireless power transmission, an alternating current circuit that can reduce reflection rate over a wider power range and enable high-efficiency AC to DC conversion is desired.

Further, since the antenna uses resonance within the antenna member, the frequency band that can be efficiently transmitted is narrow and limited to a single frequency. An antenna capable of accommodating a wider bandwidth or multiple frequencies is therefore demanded.

An object of the present invention is to provide an alternating current circuit that prevents reflection over a wider power range.

An alternating current apparatus according to an aspect of the present invention includes: a transmission line of an output impedance Z_{C} with one end point connected to an alternating current power source; a plurality of phase shifters connected to the other end point of the transmission line; and an alternating current circuit connected to each of the plurality of phase shifters. Each of the plurality of phase shifters has a phase shift angle and a characteristic impedance with which a real part of a composite admittance as viewed from the other end point is 1/Z_{C} and an imaginary part is zero for a plurality of conditions of an input signal.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram illustrating a circuit for transmitting power from a power source to a load using a rectifier circuit;

FIG. 2 is a diagram illustrating a circuit that transmits power from a power source to a load with a connected rectenna using a matching circuit and a harmonics cutoff filter;

FIG. 3 is a diagram illustrating a circuit in which the input transmission line is branched at a branch point, and the alternating current circuits are connected in parallel;

FIG. 4 is a diagram illustrating an example of an alternating current circuit serving as a load;

FIG. 5 is a Smith chart representation of a reflection wave from the alternating current circuit;

FIG. 6 is a diagram illustrating an example in which a matching circuit is connected between an input and a branch point;

FIG. 7 is a diagram illustrating a circuit in which the input transmission line is branched at a branch point into a first line and a second line, and a phase shifter is connected to the input of an alternating current circuit in each line;

FIG. 8 is a diagram illustrating a rectifier circuit, which is a basic portion of a rectenna circuit;

FIG. 9 is a diagram illustrating a rectenna circuit with an LPF added to the basic circuit;

FIG. 10 is a diagram illustrating a rectenna circuit with an LPF and a matching circuit added to the basic circuit;

FIG. 11 is a diagram illustrating a reflection rate and efficiency of RF/DC conversion for input power in a rectenna circuit;

FIG. 12 is a diagram illustrating a circuit that suppresses reflection in a rectenna circuit by utilizing the phase difference between reflection waves between lines;

FIG. 13 is a Smith chart representation of the reflection wave corresponding to the input signal;

FIG. 14 is a diagram illustrating an example in which a plurality of antennas are connected in parallel;

FIG. 15 is a diagram illustrating the reflection characteristics for an input signal of the antenna;

FIG. 16 is a Smith chart illustrating impedance matching;

FIG. 17 is a diagram illustrating an example in which the branching of the input is stacked in a multistage manner;

FIG. 18 is a diagram illustrating an example in which a plurality of antennas are connected in parallel, and a phase shifter is provided at the input of each line;

FIG. 19 illustrates a reflection rate of a case where impedance matching is performed for four frequencies;

FIG. 20 is a diagram illustrating an example in which a plurality of rectifier circuits are connected in parallel, and a phase shifter is provided at the input of each rectifier circuit;

FIG. 21 is a diagram illustrating a reflection rate and an efficiency of RF/DC conversion of the case with a branch into multiple lines;

FIG. 22 is a complex representation of admittances at branch points when the input signals of the lines change the power from 0.1 W to 50 W;

FIG. 23 is a diagram illustrating a rectenna circuit using a matching circuit with an LC circuit;

FIG. 24 is a diagram illustrating a circuit in which an LC circuit is used for the phase shifter of the parallel-connected rectenna circuit; and

FIG. 25 is a diagram illustrating the RF/DC conversion efficiency and the reflection rate of a case where the input power is varied.

### DESCRIPTION OF EMBODIMENTS

As described below, the alternating current circuit of the present disclosure makes it possible to suppress reflection for conditions with a plurality of input signals only by adjusting the phase shift angle of the phase shifter.

By combining the rectenna circuit with the matching circuit, it is possible to suppress reflection and maintain high efficiency of the radio frequency/direct current (RF/DC) conversion for a wide range of input power or frequencies. Further, when it is used for the antenna, it is possible to radiate signals in a plurality of bands.

Alternatively, it is possible to widen the radiation band by arranging multiple bands close to each other.

### Rectenna

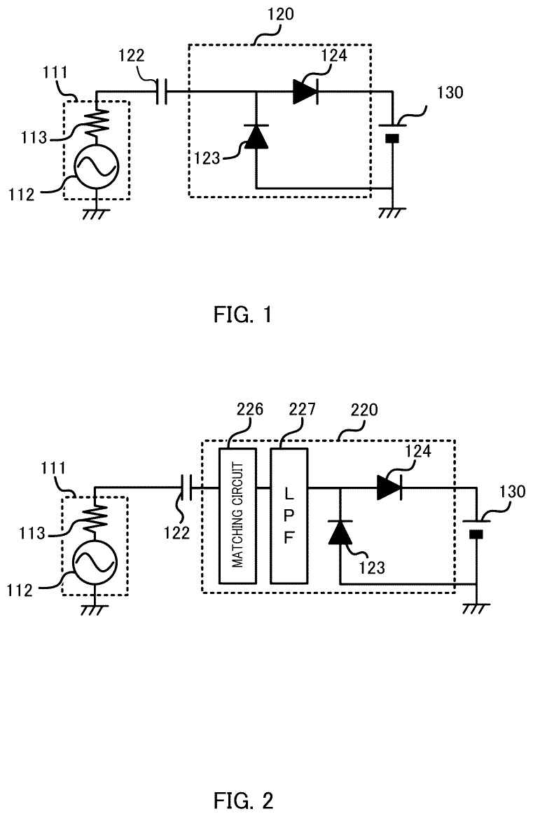

Before describing the details of the present invention, problems in a rectifier circuit will be described first. FIG. 1 is a diagram illustrating a circuit for transmitting power from a power source to a load using a rectifier circuit.

The circuit illustrated in FIG. 1 includes power source 111, capacitor 122, rectifier circuit 120, and load 130. The load may be a constant-voltage load or another type of load such as a constant-resistance load.

Power source 111 is understood as an equivalent circuit including oscillator 112 and power resistor 113.

Power source 111 generates the microwave to be transmitted. The frequency of the microwave generated by power source 111 is, for example, 5.8 GHz. In wireless power transmission, the power source is a power receiving antenna.

Rectifier circuit 120 includes diode 123 and diode 124. The anode of diode 123 is connected to ground. The cathode of diode 124 is connected to one side of load 130. The other side of load 130 is connected to ground. Load 130 is a constant-resistance load or a constant-voltage load. In any case, the voltage between the cathode of diode 124 and ground needs to be constant, and therefore a smoothing circuit using a capacitor or a stub is connected to this part in cases other than the constant-voltage load.

One side of capacitor 122 is connected to power source 111, and the other side of capacitor 122 is connected to the connection point between the cathode of diode 123 and the anode of diode 124 in rectifier circuit 120. In the rectifier circuit, a direct current voltage is generated by the conversion of the signal, but capacitor 122 is provided to separate the direct current voltage at the rectenna circuit and the signal source side, with a sufficiently large value that does not affect the alternating current characteristics.

Rectifier circuit 120 in FIG. 1 is called a voltage doubler circuit.

Rectifier circuit 120 may be a single shunt circuit including one diode and a λ/4 line.

When the microwave signal is input to rectifier circuit 120, reflection occurs at the connection point between the cathode of diode 123 and the anode of diode 124. When viewed from the power transmission apparatus side, the rectifier circuit using diodes appears to include a parallel connection of the capacitance during the off-state of diode 123 and diode 124 and the effective resistance of load 130. The effective resistance value in the case where the load is a constant-voltage power source is determined by the voltage of the power source and the current flowing into the power source. The complex impedance resulting from the parallel connection of this capacitance and resistance generates a mismatch with the impedance of the input transmission line, causing reflections. Reflection is a loss for a rectenna circuit.

FIG. 2 illustrates a circuit that supplies power from power source 111 to load 130 in which rectenna circuit 220 using matching circuit 226 and harmonic block or low-pass filter 227 (LPF) is connected.

One side of matching circuit 226 is connected to the other side of capacitor 122, and the other side of matching circuit 226 is connected to one side of LPF 227.

The other side of LPF 227 is connected to the cathode of diode 123 and the anode of diode 124.

Matching circuit 226 is connected because for the purpose of preventing reflection it is common for a high frequency circuit to use a matching circuit to suppress reflection and prevent a decrease in efficiency.

Further, since the diode has a non-linear characteristic with respect to the input voltage, the reflection wave includes harmonics of the input signal even when a sine wave alternating current signal is input. Since the reflection of the harmonic is also a loss, LPF 227 is connected to confine the harmonic generated internally, thereby preventing the release of the harmonic as a reflection wave. Thus, in the circuit in FIG. 2, the reflection wave is only the fundamental wave as viewed from matching circuit 226, and in this manner impedance matching can be achieved.

In the case where load 130 is a constant-voltage load, the current that flows into the load with the input power varies, and thus the effective resistance value varies with the power when the load is regarded as a resistor. In the case where load 130 is a constant-resistance load, the resistance value does not change, but the direct current voltage of the output varies with the input power. As a result, the average voltage applied to the diode in the off state changes, and the depletion layer capacitance changes.

That is, in the case where the input power changes, the input impedance of the rectenna circuit changes even with the constant-voltage load or the constant-resistance load. This indicates that, even when the reflection is set to zero by performing matching under a certain input condition, reflection occurs when the input power changes. As a result, the high-efficiency state with a low reflection rate is limited to a narrow range of impedance-matched input conditions.

### Embodiment 1: Branching of Line in RC Circuit

Now a method of suppressing reflection in an alternating current circuit by branching the line and using a phase shifter, which is a main subject of the present invention, will be described with reference to an example of a simple circuit.

When a sine wave is input into the alternating current circuit, the alternating current circuit reflects this input signal according to its characteristics.

In the case where the reflection wave is only the fundamental wave, the reflection can be suppressed by controlling the amplitude and the phase of the reflection wave with a capacitor and an inductor, an impedance line of a finite length and a stub, or the like. However, in the case where an alternating current circuit can be composed of two circuits connected in parallel, it is possible to suppress reflection by inserting a phase shifter into each of the two circuits and controlling the phase shift delay (phase shift angle) without using a matching circuit.

The following describes a circuit in which the input power is branched into two lines at a branch point, and reflection is suppressed using the phase difference between reflection waves between the lines without using a matching circuit.

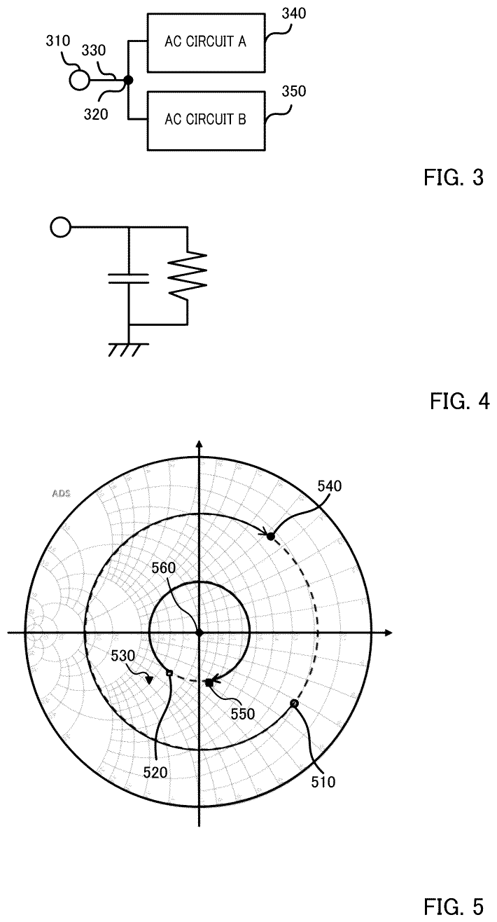

FIG. 3 is a circuit diagram in which input transmission line 330 connected to input terminal 310 is branched at branch point 320, and alternating current circuit A340 and alternating current circuit B350 are connected in parallel to each other.

FIG. 4 is a diagram illustrating an example of an alternating current circuit that serves as a load in FIG. 3. The alternating current circuit is composed of a circuit in which a resistor and a capacitor are connected in parallel, for example.

FIG. 5 is a Smith chart representation of a reflection wave for a signal in the circuits of FIGS. 3 and 4. The normalized impedance is 50Ω.

It is assumed that alternating current circuit A340 illustrated in FIG. 3 is composed of a parallel connection of a 240Ω resistor and a 100 pF capacitor, for example. In the case where a signal with a frequency of 10 MHz is supplied from the signal source with a characteristic impedance of 50Ω to this circuit, the reflection coefficient is indicated by reflection coefficient 510 as the white circle in the Smith chart of FIG. 5.

It is assumed that alternating current circuit B350 in FIG. 3 is composed of a 40Ω resistor and a 200 pF capacitor connected in parallel, for example. In the case where a signal with a frequency of 10 MHz is supplied from the signal source with a characteristic impedance of 50Ω to this circuit, the reflection coefficient is indicated by the reflection coefficient 520 as the white square in the Smith chart of FIG. 5.

Further, in the case where a signal with a frequency of 10 MHz from the signal source with a characteristic impedance of 50Ω is applied to a circuit with alternating current circuit A340 and alternating current circuit B350 connected in parallel as illustrated in FIG. 3, the reflection coefficient is indicated by reflection coefficient 530 as the black triangle in the Smith chart of FIG. 5.

As illustrated in FIG. 5, none of the circuits is matched to the signal source with a characteristic impedance of 50Ω.

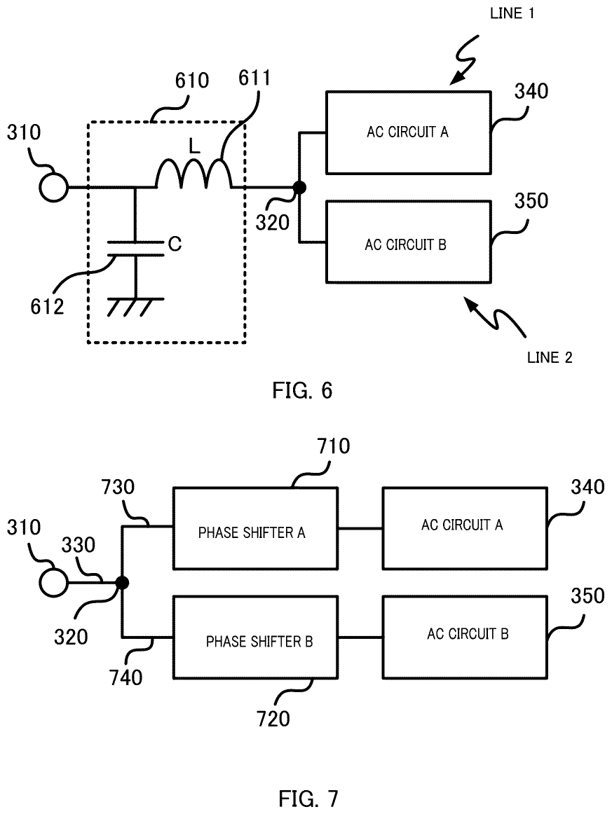

For example, in the related art, a matching circuit is connected between input terminal 310 and branch point 320 in FIG. 3 to perform impedance matching. FIG. 6 illustrates an example in which matching circuit 610 is connected between input terminal 310 and branch point 320.

Matching circuit 610 is composed of inductor 611 and capacitor 612. In FIG. 6, in the case where impedance matching at a frequency of 10 MHz is performed on input terminal 310 with an impedance of 50Ω, the use of inductor 611 with 647 nH (L=647 nH) and capacitor 612 with 329 pF (C=329 pF) makes it possible to set the coordinates of the reflection wave as viewed from input terminal 310 to the origin 560, thereby eliminating the reflection.

In the case where two alternating current circuits are connected in parallel as illustrated in FIG. 3, no reflection occurs when the composite admittance as viewed from branch point 320 is in a complex conjugate relationship with the signal source impedance. That is, it suffices to set the real part of the composite admittance to the reciprocal of the signal source impedance, i.e., 20 mS, and the imaginary part to zero.

This is also possible by connecting a phase shifter to the input of each alternating current circuit. Each “series of circuits that are connected in series” that are branched from branch point 320 and are connected in parallel is referred to as a “line”.

FIG. 7 illustrates a circuit in which input transmission line 330 is branched into first line 730 and second line 740 at branch point 320 such that phase shifter A710 is connected to the input of alternating current circuit A340 in first line 730, and that phase shifter B720 is connected to the input of alternating current circuit B350 in second line 740.

The reflection wave returning to branch point 320 from first line 730 and second line 740 is a composite of the reflection waves from the respective lines. Since the signal frequency of the reflection wave is the same as that of the incident wave, the composite reflection waves can be uniquely represented by two parameters, i.e., the amplitude and the phase difference with respect to the input signal. That is, in order to perform impedance matching, it suffices to optimize the two parameters, i.e., the amplitude and the phase difference with respect to the input signal.

Since each phase shifter has two parameters, i.e., the characteristic impedance and the phase shift angle, there are four parameters in total in the two phase shifters. In this case, matching is performed by adjusting the phase shift angle of each phase shifter with the characteristic impedance fixed to 50Ω.

In the Smith chart of FIG. 5, a change in the coordinates (reflection coefficient) of the reflection wave of the phase shifter with a characteristic impedance of 50Ω is a circular movement around the origin.

When the phase shift angle of phase shifter A710 is set to 135.5 degrees, the reflection wave moves from reflection coefficient 510 to reflection coefficient 540. Reflection coefficient 540 is a reflection corresponding to a load with an admittance of (0.00467−j0.0095) S.

When the phase shift angle of phase shifter B720 is set to 155.8 degrees, the reflection wave moves from reflection coefficient 520 to reflection coefficient 550. Reflection coefficient 550 is a reflection corresponding to an admittance of (0.01533+j0.0095) S.

The composite admittance as viewed from branch point 320 is the sum of two admittances, i.e., (0.02+j0)S, and thus it can be matched to the signal source with a characteristic impedance of 50Ω.

Since there is a limitation that the adjustment range of the admittance depends on the original impedance value, it is not always possible, but accurate adjustment can be achieved within the adjustable range. When matching is performed in this manner, reflections occur within the first line 730 and the second line 740 connected to the branch point 320, but these reflections remain within each line and do not exit outside the branch point 320 (to the input transmission line 330 side).

### Embodiment 2: Rectenna Circuit

An example in which the principle of the present invention is applied to the reflection suppression in the rectenna circuit described above will be described. The following describes reflection suppression in a rectenna circuit using a Schottky barrier diode (SBD) made of gallium nitride (GaN) as the diode.

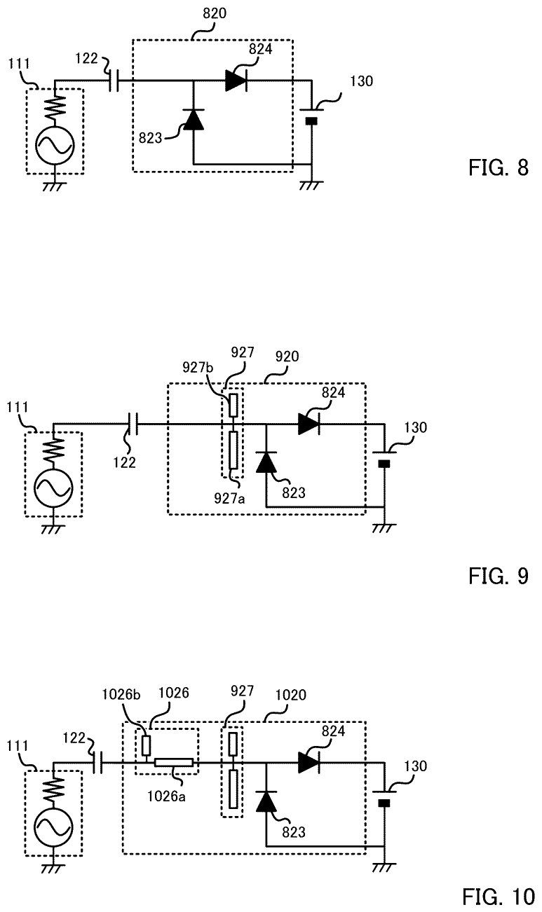

FIGS. 8 to 10 are diagrams illustrating the rectenna circuit used in the calculation. FIG. 8 is a diagram illustrating the rectifier circuit, which is a basic portion of the rectenna circuit. FIG. 9 is a diagram illustrating a rectenna circuit with LPF 927 added to the basic portion. FIG. 10 is a diagram illustrating a rectenna circuit with LPF 927 and matching circuit 1026 added to the basic portion.

The output of power source 111 is connected to one side of capacitor 122. The other side of capacitor 122 is connected to the cathode of SBD 823 and the anode of SBD 824. Capacitor 122 can separate the direct current voltage of the rectenna circuit and the signal source. The anode of SBD 823 is connected to ground. The cathode of SBD 824 is connected to load 130.

SBD 823 and SBD 824 make up rectifier circuit 820.

SBD 823 and SBD 824 each use sixteen dot (small circular) diodes with a diameter of 4 μm connected in parallel. The capacitance in an off state at one dot is 0.03 pF, the resistance in an on state is 26Ω, and the constant-voltage load is 60V due to withstand voltage limitations.

FIG. 9 illustrates rectifier circuit 920 in which an LPF 927 is connected to the rectifier circuit 820. SBD 823 and SBD 824 are the same as in FIG. 8.

LPF 927 is formed using a 50Ω microstrip line on a substrate with a relative dielectric constant of 4.2. The frequency of the microwave is 5.8 GHz, and the wavelength of a signal in the microstrip line on the substrate is approximately 28 mm. LPF 927 is composed of a third-harmonic band elimination filter (BEF) 927a and a fifth-harmonic BEF 927b.

BEF 927a is an open stub of a microstrip line of L=2.1 mm (0.083λ= 1/12λ). BEF 927b is an open stub of a microstrip line of 1.26 mm (0.05λ= 1/20λ). BEF 927a and BEF 927b are each connected to the other side of capacitor 122, the cathode of SBD 823, and the anode of SBD 824.

Note that LPF 927 may be a filter that removes only the third harmonic, or may be a filter that removes harmonics beyond the fifth harmonic. Further, LPF 927 may be created with another configuration. In the case where the frequency is low, LPFs composed of LC circuits may be used instead of BEF 927a and BEF 927b.

FIG. 10 illustrates rectenna circuit 1020 in which a matching circuit 1026 is connected to the rectifier circuit 920. SBD 823, SBD 824, and LPF 927 are the same as in FIG. 9.

The matching circuit 1026 is composed of microstrip line 1026a and open stub microstrip line 1026b connected in series. Matching circuit 1026 may be created with another configuration.

One side of microstrip line 1026a is connected to the other side of capacitor 122 and microstrip line 1026b, and the other side of microstrip line 1026a is connected to the cathode of SBD 823, the anode of SBD 824, BEF 927a, and BEF 927b.

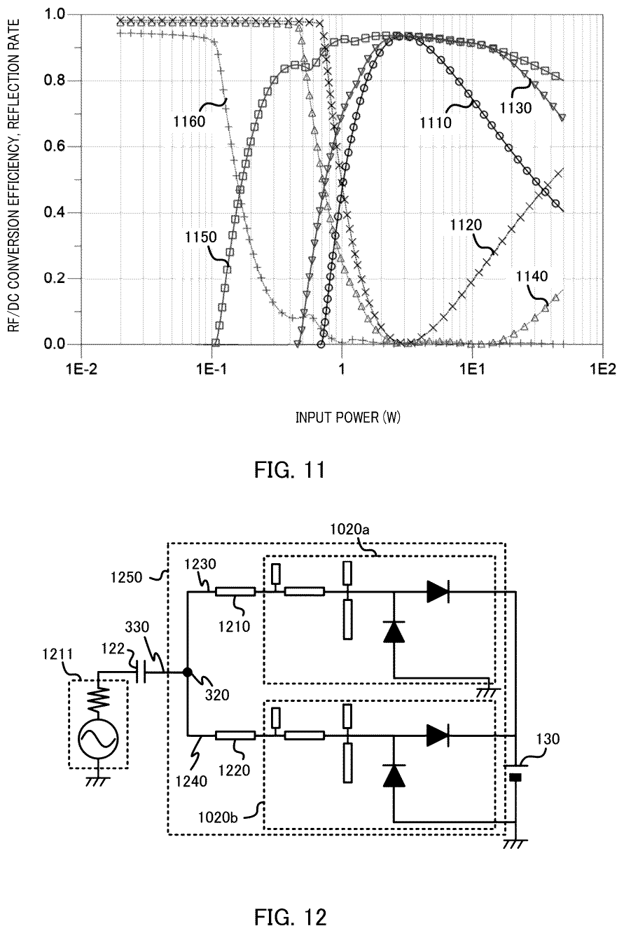

Here, a line with L=0.153λ is used as microstrip line 1026a and a stub with L=0.195λ is used as microstrip line 1026b such that the input power Pin is matched with 3 W. FIG. 11 is a diagram illustrating the reflection rate to the input side and the efficiency of the RF/DC conversion (conversion from microwave power to direct current power) for the input power of the circuit in FIG. 10. In FIG. 11, line 1110 indicates the RF/DC conversion efficiency and line 1120 indicates the reflection rate (power reflection rate). At Pin=3 W, the reflection rate is 0 and the RF/DC conversion efficiency is maximum. However, the RF/DC conversion efficiency is high (for example, 90% or more) only when the power of the input signal is within a range of 2.5 W to 4 W.

FIG. 12 is a diagram illustrating a circuit that suppresses reflection using the phase difference between reflection waves in the lines, in which the input is divided into two lines. In FIG. 12, each line includes a matching circuit, and the reflection is suppressed at Pin=3 W by its effect.

Input transmission line 330 has a characteristic impedance of 25Ω, and first line 1230 and second line 1240 have a characteristic impedance of 50Ω.

Input transmission line 330 includes power source 1211 and capacitor 122. One side of capacitor 122 is connected to the output of power source 1211, and the other side of capacitor 122 is connected to branch point 320.

First line 1230 includes phase shifter 1210 and rectenna circuit 1020a. Rectenna circuit 1020a is the same as rectenna circuit 1020 in FIG. 10.

Second line 1240 includes phase shifter 1220 and rectenna circuit 1020b. Rectenna circuit 1020b is the same as rectenna circuit 1020a.

Branch point 320, phase shifter 1210, rectenna circuit 1020a, phase shifter 1220, and rectenna circuit 1020b make up rectenna circuit 1250.

Power source 1211 has an output impedance of 25Ω.

In the case where 6 W of power is output from power source 1211, 3 W of power is input to each of first line 1230 and second line 1240. As illustrated in FIG. 10, rectenna circuits 1020a and 1020b are matched for an input power of 3 W, and therefore no reflection occurs regardless of the phase shift amount of the phase shifter.

Now the following considers a case where a power source of 20 W is output from power source 1211. In this case, assuming that there is no reflection in the transmission line, 10 W of power is input to first line 1230 and second line 1240, but reflection occurs because matching circuit 1026 is matched with 3 W. In view of this, in the case where 10 W of power is input, the phase amounts of phase shifters 1210 and 1220 of first line 1230 and second line 1240 are adjusted such that the composite impedance of first line 1230 and second line 1240 has only a real part of 25Ω.

Such adjustment of phase shifters 1210 and 1220 will be described using a Smith chart.

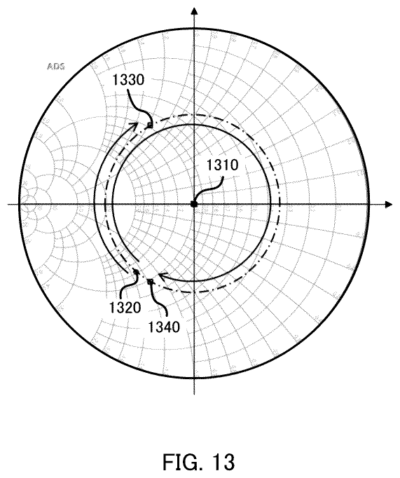

FIG. 13 illustrates a Smith chart representation of the reflection wave corresponding to the input signal in the circuit of FIG. 12.

The circuit in FIG. 12 is matched for an input power of 3 W, and therefore the coordinates for an input power of 3 W are at the origin 1310. Next, the following considers a case where 10 W of power is input to each line of the circuit in FIG. 12 in which rectenna circuit 1020a and rectenna circuit 1020b are disposed. Since the two rectifier circuits are already matched for Pin=3 W, reflection occurs at 10 W. The reflection coefficient for a 10W input inside the rectifier circuit corresponds to an external input of 13.55 W, considering its reflection rate. In that case, the reflection coefficient is reflection coefficient 1320.

When reflection coefficient 1320 is moved to reflection coefficients 1330 and 1340 on the equal conductance circle of 50Ω by using phase shifters 1210 and 1220, the imaginary parts of the impedances cancel each other out, and thus the composite impedance has only the real part of 25Ω. Thus, it is equal to the impedance of 25Ω of input transmission line 330, which makes it possible to suppress reflection. When the phase shift angle in phase shifter 1210 is set to 55.44 degrees, the reflection coefficient moves from reflection coefficient 1320 to reflection coefficient 1330, and when the phase shift angle in phase shifter 1220 is set to 175.58 degrees, the reflection coefficient moves from reflection coefficient 1320 to reflection coefficient 1340.

For the circuit of FIG. 12, the RF/DC conversion efficiency with respect to input power is indicated by line 1130 and reflection rate is indicated by line 1140 in FIG. 11. Here, the horizontal axis represents the input power to the unit line, and the output power of the power source in the case of two lines is twice this. The same applies to FIGS. 21 and 26 to be described later. The reflection rate illustrated in line 1140 is close to zero between Pin=3 W and 10 W, and the RF/DC conversion efficiency illustrated in line 1130 is kept at a value of 90% or more between 1.7 W and 13 W.

Line 1130 representing the RF/DC conversion efficiency of the circuit in FIG. 12 maintains high efficiency over a wide input power range compared to line 1110 in the case of a single line. This indicates that highly efficient RF/DC conversion is performed even when the electrical power of the input signal significantly varies, and is thus particularly advantageous in, for example, radio power transmission where the transmission power is likely to fluctuate.

### Embodiment 3: Antenna

Next, a case where the principle of the present invention is applied to an antenna circuit will be described.

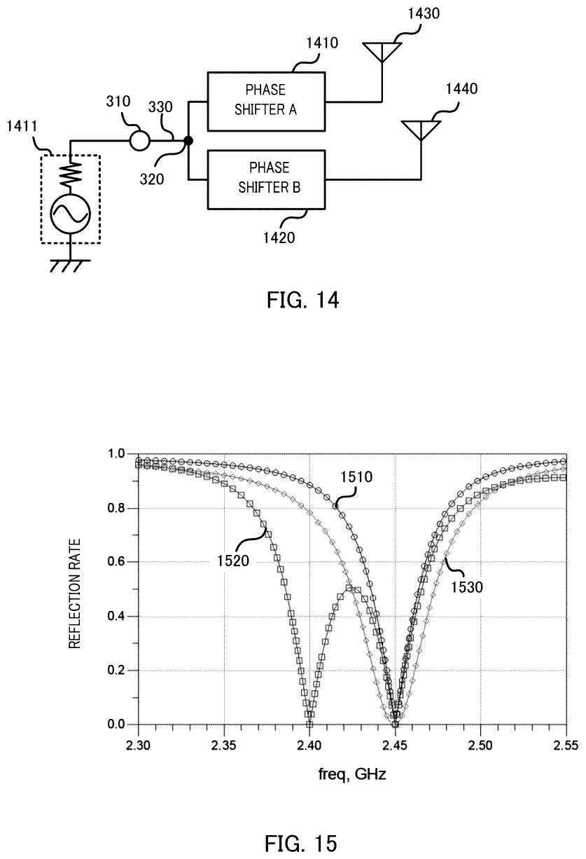

FIG. 14 illustrates an example in which multiple antennas are connected in parallel. The following describes matching in the case where the frequency of an input signal varies.

Power source 1411 is connected to input terminal 310, and antenna A1430 and antenna B1440 are connected in parallel at branch point 320 through phase shifter A1410 and phase shifter B1420, respectively. Antenna A1430 and antenna B1440 have the same characteristics.

For example, the antenna is a patch antenna with a characteristic impedance of 50Ω and causes no reflection when the input signal frequency is 2.45 GHz, i.e., an antenna that radiates a radio wave.

FIG. 15 is a diagram illustrating reflection characteristics for the input signal frequency of the antenna. Line 1510 indicates the reflection rate for an input signal with a single antenna. Line 1510 indicates that the reflection rate is 0 at 2.45 GHz and that all the input signals are emitted from the antenna at this frequency.

As illustrated in FIG. 14, in the case where a phase shifter is connected to the input of each antenna and the characteristic impedance of each phase shifter is set to 50Ω, which is the same as the characteristic impedance of the antenna, the composite impedance at branch point 320 is 25Ω. Further, when the characteristic impedance of input transmission line 330 from input terminal 310 to branch point 320 is set to 25Ω, impedance matching at branch point 320 is established, and thus, no reflection occurs at branch point 320. The input signal of 2.45 GHz does not cause reflection even at the antenna portion, and thus, no reflection occurs as a whole.

While impedance matching for the input signal of 2.45 GHz is performed for this antenna, it is also possible to perform matching for other frequency conditions by utilizing the phase shift angle in each phase shifter. For example, matching for the input signal of 2.40 GHz can be achieved.

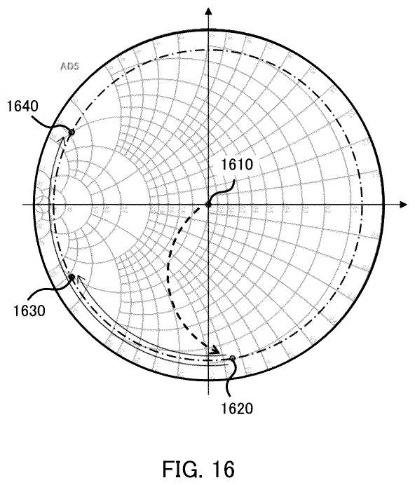

The following describes a case where impedance matching for 2.40 GHz is achieved using a phase shifter with reference to the Smith chart of FIG. 16.

Since both antennas cause no reflection at 2.45 GHZ, the reflection coefficient of each antenna at the input signal of 2.45 GHz is the origin 1610. In the case of the input signal of 2.40 GHz, the reflection coefficients of both antennas move to 1620 due to the change in the input frequency.

In the case where a phase shifter with a characteristic impedance of 50Ω is connected to the antenna, the reflection coefficient moves on a circumference centered on the origin. For example, in the case where the phase shift angle of phase shifter A1410 is set to 36.4 degrees, reflection coefficient 1620 moves to 1630. In the case where the phase shift angle of phase shifter B1420 is set to 64.65 degrees, reflection coefficient 1620 moves to 1640.

Since the reflection wave passes through the phase shifter twice, the movement in the Smith chart corresponds to twice the phase shift angle of the phase shifter. Both reflection coefficient 1630 and reflection coefficient 1640 are present on an equal conductance circle where the admittance is 20 mS. Further, the imaginary parts of reflection coefficient 1630 and reflection coefficient 1640 have the same absolute value and are opposite in sign.

In this manner, the composite admittance as viewed from branch point 320 has a real part of 40 mS and an imaginary part of 0. This indicates that the impedance is matched when the input signal line is 25Ω.

The matching is established at 2.45 GHz regardless of the phase shifter, and as a result the circuit that causes no reflection at the two frequencies, 2.40 GHz and 2.45 GHz can be achieved. This reflection characteristic is indicated by line 1520 in FIG. 15.

Line 1530 in FIG. 15 indicates reflection characteristics of a case where the input signal is 2.449 GHz, which is substantially equal to 2.45 GHz, as a second matching condition. Referring to line 1530, it is understood that the center frequency is 2.45 GHz, which is almost the same as that of line 1510 indicating the case of the single antenna, but the bandwidth is wider.

Note that, since the phase of a signal radiated from the antenna is different between the two antennas due to the phase shifter, interference occurs and complex directivity is generated in the antenna depending on the distance between the antennas, the orientation of the antennas, and the like. The directivity of an antenna can be advantageous or disadvantageous depending on the application.

### Embodiment 4: Multi-Stage Stack

The reflection suppression circuit that branches into two lines can be stacked in multiple stages. Here, a rectenna circuit will be described as an example again.

In the rectenna circuit in FIG. 12, rectenna circuits 1020a and 1020b, which suppress reflections for an input power of 3 W, are configured to also suppress reflections for an input power of 10 W with phase shifters 1210 and 1220.

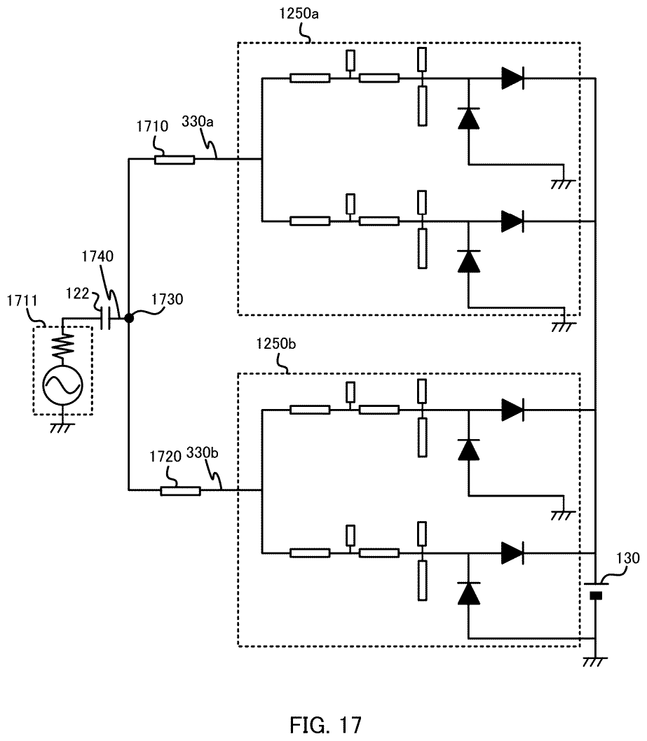

FIG. 17 is a diagram illustrating a circuit that combines two of the circuits illustrated in FIG. 12.

Input transmission line 1740 has a characteristic impedance of 12.5Ω, and first line 330a and second line 330b have a characteristic impedance of 25Ω.

Input transmission line 1740 includes power source 1711 and capacitor 122. One side of capacitor 122 is connected to the output of power source 1711, and the other side of capacitor 122 is connected to branch point 1730.

First line 330a includes phase shifter 1710 and rectenna circuit 1250a. One side of phase shifter 1710 is connected to the branch point 1730, and the other side of phase shifter 1710 is connected to the rectenna circuit 1250a. Rectenna circuit 1250a is the same as rectenna circuit 1250 in FIG. 12.

Second line 330b includes phase shifter 1720 and rectenna circuit 1250b. One side of phase shifter 1720 is connected to the branch point 1730, and the other side of phase shifter 1420 is connected to the rectenna circuit 1250b. Rectenna circuit 1250b is the same as rectenna circuit 1250a.

Branch point 1730 branches input transmission line 1740 into first line 330a and second line 330b.

As illustrated in FIG. 12, rectenna circuits 1250a and 1250b are matched for the input power of 6 W or 20 W, and thus, no reflection occurs regardless of the phase shift amount of phase shifters 1710 and 1720.

In the case where power source 1711 outputs power of 4 W, 2 W of power is input to first line 330a and second line 330b, and reflection from rectenna circuit 1250a and rectenna circuit 1250b occurs. In view of this, in the case where power source 1711 outputs 4 W of power, i.e., in the case where 1 W of power is input to the unit rectifier circuit, the phase shift angle of phase shifter 1710 in first line 330a and the phase shift angle of phase shifter 1720 in second line 330b are adjusted to ensure that the composite impedance of first line 330a and second line 330b as viewed at branch point 1730 is 12.5Ω of only the real part.

To ensure that the real parts of the impedances are equal to each other and the absolute values of the imaginary parts of the impedances are the same at the input power 1 W of the unit rectifier circuit, it suffices to set the phase shift angle in the phase shifter 1710 and the phase shift angle in the phase shifter 1720 to 57.6 degrees and 119.5 degrees, respectively.

With the phase shift angle in each phase shifter as described above, the composite impedance of first line 330a and second line 330b is only the real part of 12.5Ω, which is the same as the impedance of input transmission line 1740, i.e., 12.5Ω, and thus reflection is suppressed.

In the circuit in FIG. 17, the absolute values of the RF/DC conversion efficiency and the reflection rate for the input power are indicated with lines 1150 and 1160 in FIG. 11.

In FIG. 11, line 1110 indicates the RF/DC conversion efficiency in the case where only the reflection of 3 W is suppressed, line 1120 indicates the reflection rate in the case where the reflection of only 3 W is suppressed, line 1130 indicates the RF/DC conversion efficiency in the case where the reflections of 3 W and 10 W are suppressed, line 1140 indicates the reflection rate in the case where the reflections of 3 W and 10 W are suppressed, line 1150 indicates the RF/DC conversion efficiency in the case where the reflections of 1 W, 3 W, and 10 W are suppressed, and line 1160 indicates the reflection rate in the case where the reflections of 1 W, 3 W, and 10 W are suppressed.

According to line 1150, it is understood that the range of the highly efficient input power is expanded to 0.8 W to 20 W.

### Embodiment 5: Line with Three or More Branches; Antenna

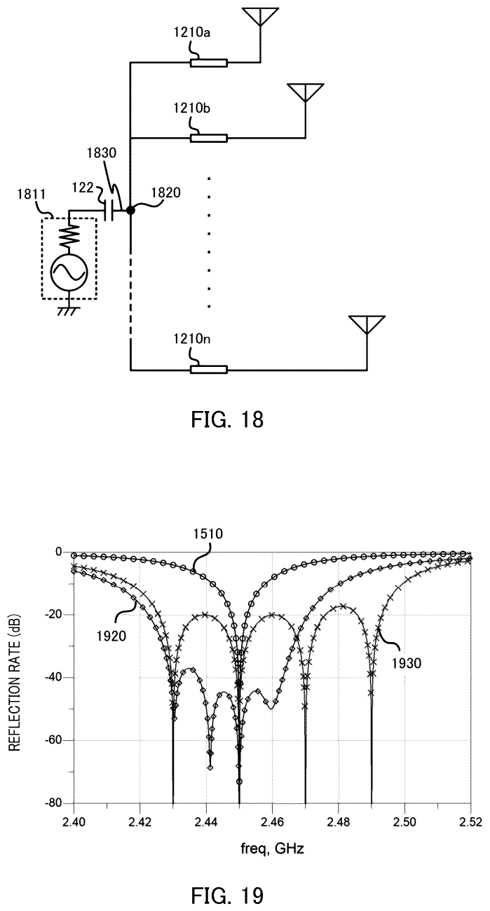

Although the method in which the line is divided into two lines has been described above, it is also possible to achieve impedance matching with a circuit with three or more alternating current circuits connected in parallel and a phase shifter connected to the input of each circuit. In this case, the number of adjustable parameters increases, making it possible to cope with more changing input conditions. Now an example of transmission at a plurality of frequencies in an antenna will be described. FIG. 18 illustrates an example in which a plurality of lines are parallel-connected to branch point 1820 and antennas are connected, with phase shifters 1210a to 1210n provided at the inputs of the respective lines.

Since impedance matching needs to control two parameters, namely the phase and the amplitude of a reflection wave, it is necessary to have two control parameters for one input condition (input power or frequency) in order to perform impedance matching.

For example, six control parameters are required in order to perform impedance matching for three frequencies. In this case, six phase shift angles may be controlled with six phase shifters each having the same characteristic impedance, or three characteristic impedances and three phase shift angles of three phase shifters may be used. The use of six phase shifters needs only to branch the line into six at branch point 1820, and the use of three phase shifters needs only to branch the line into three at branch point 1820.

Line 1920 in FIG. 19 indicates reflection rates of a case where impedance matching is performed for three frequencies, namely 2.43 GHZ, 2.44 GHZ, and 2.46 GHz, in addition to the 2.45 GHz by using six antennas used in FIG. 14, and six phase shifters, each with a characteristic impedance of 50Ω.

Line 1510 in FIG. 19 illustrates a reflection rate for an input signal of a single antenna. By setting the characteristic impedance of input transmission line 330 to ⅙ of 50Ω, i.e., 8.33Ω, impedance matching is achieved at branch point 1820. In the case of 2.45 GHz, the overall matching is achieved even when viewed from power source 1811 because matching is achieved at each antenna.

However, this alone does not achieve matching at frequencies other than 2.45 GHz. Therefore, the phase shift angles of the six phase shifters are adjusted to set the reflection at 2.43, 2.44, and 2.46 GHz to zero. For this purpose, the optimization function of the simulator is used, and the six parameters are randomly varied to find the optimum solution. Reflection could not be completely reduced to zero at three frequencies, but it could be reduced to a sufficiently low value, i.e., to −50 dB. Table 1 illustrates the phase shift angles of the six phase shifters in this case and the input admittances of the respective lines as viewed from branch point 1820. In Table 1, Yre represents the real part of admittance, and Yim represents the imaginary part of admittance.

TABLE 1

| | | Phase shift | Frequency | | | | | | | |
|---|---|---|---|---|---|---|---|---|---|---|
| | | angle | 2.43 GHz | | 2.44 GHz | | 2.45 GHz | | 2.46 GHz | |
| Line | Zc | (degree) | Yre | Yim | Yre | Yim | Yre | Yim | Yre | Yim |
| 1 | 50 | 23.45 | 45.9 | 41.3 | 43.5 | 5.3 | 20.0 | 0.0 | 9.7 | 5.7 |
| 2 | 50 | 48.82 | 48.1 | −41.3 | 29.2 | −17.5 | 20.0 | 0.0 | 14.9 | 13.6 |
| 3 | 50 | 84.51 | 8.0 | −16.5 | 11.8 | −9.6 | 20.0 | 0.0 | 41.2 | 11.4 |
| 4 | 50 | 110.30 | 5.0 | −5.7 | 9.1 | −2.1 | 20.0 | 0.0 | 33.4 | −17.0 |
| 5 | 50 | 158.11 | 6.1 | 11.0 | 13.5 | 11.7 | 20.0 | 0.0 | 10.3 | −7.2 |
| 6 | 50 | 158.18 | 6.1 | 11.1 | 13.5 | 11.8 | 20.0 | 0.0 | 10.3 | −7.2 |

| | | | | | | | | |
|---|---|---|---|---|---|---|---|---|
| Total | 119.2 | −0.1 | 120.7 | −0.3 | 120.0 | 0.0 | 119.9 | −0.8 |

(unit: mS)

The sum of the real parts of the admittances of the parallel-connected phase shifters is substantially 120 mS for all four frequencies, and the sum of the imaginary parts is substantially 0 mS. This indicates that impedance matching is established. Since the phase shift angle simultaneously changes the real part and the imaginary part of the admittance, it is not possible to independently set the three real parts and the three imaginary parts of the admittance, and therefore complete matching was not achieved, while it can be understood that sufficiently practical impedance matching over a wide frequency range is achieved.

Next, line 1930 of FIG. 19 indicates reflection rates of a case where impedance matching is performed for four frequencies, namely 2.43 GHZ, 2.45 GHZ, 2.47 GHz, and 2.49 GHz by using four antennas and four phase shifters each having a variable characteristic impedance in FIG. 18.

In this case, the characteristic impedance of the input transmission line 330 is ¼ of 50Ω, i.e., 12.5Ω. Here, the phase shifter controls the characteristic impedance along with the phase shift angle. An impedance line having various characteristic impedances can be created in a microstrip line by changing the line width or the like.

In this case, since the characteristic impedance of the phase shifter is not necessarily 50Ω, reflection may occur at the antenna entrance, and the matching may not be achieved at 2.45 GHz. That is, it is necessary to perform adjustment to achieve matching for 2.45 GHz. The characteristic impedances and the phase shift angles of four phase shifters were adjusted using the optimization function of the simulator to obtain an optimum solution. The result is a reflection of equal to or less than −80 dB at four frequencies as indicated by 1930 in FIG. 19, and it is understood that sufficient matching was achieved. Table 2 illustrates the input admittance of each line as viewed from branch point 1820 in that case. In Table 2, Yre represents the real part of admittance, and Yim represents the imaginary part of admittance.

TABLE 2

| | | Phase shift | Frequency | | | | | | | |
|---|---|---|---|---|---|---|---|---|---|---|
| | | angle | 2.43 GHz | | 2.45 GHz | | 2.47 GHz | | 2.49 GHz | |
| Line | Zc | (degree) | Yre | Yim | Yre | Yim | Yre | Yim | Yre | Yim |
| 1 | 33.25 | 31.11 | 48.0 | 56.7 | 23.5 | 8.7 | 6.4 | 20.4 | 2.8 | 27.7 |
| 2 | 38.74 | 104.04 | 8.2 | −14.3 | 32.0 | −3.9 | 32.4 | −58.6 | 6.4 | −46.5 |
| 3 | 55.14 | 56.99 | 20.3 | −31.7 | 17.4 | −1.6 | 17.8 | 28.2 | 22.4 | 66.1 |
| 4 | 92.35 | 66.36 | 3.4 | −10.2 | 6.6 | −3.2 | 22.9 | 9.8 | 48.3 | −47.9 |

| | | | | | | | | |
|---|---|---|---|---|---|---|---|---|
| Total | 80.0 | 0.5 | 79.5 | 0.1 | 79.5 | −0.1 | 80.0 | −0.5 |

(unit: mS)

Although the admittances for the respective lines are different from each other at the four frequencies, the sum of the real parts of the admittances parallel-connected to each other is substantially 80 mS, and the sum of the imaginary parts is substantially 0 mS. This matches a characteristic impedance of 12.5Ω, indicating that there is no reflection.

### Embodiment 6: Line with Three or More Branches; Rectenna Circuit

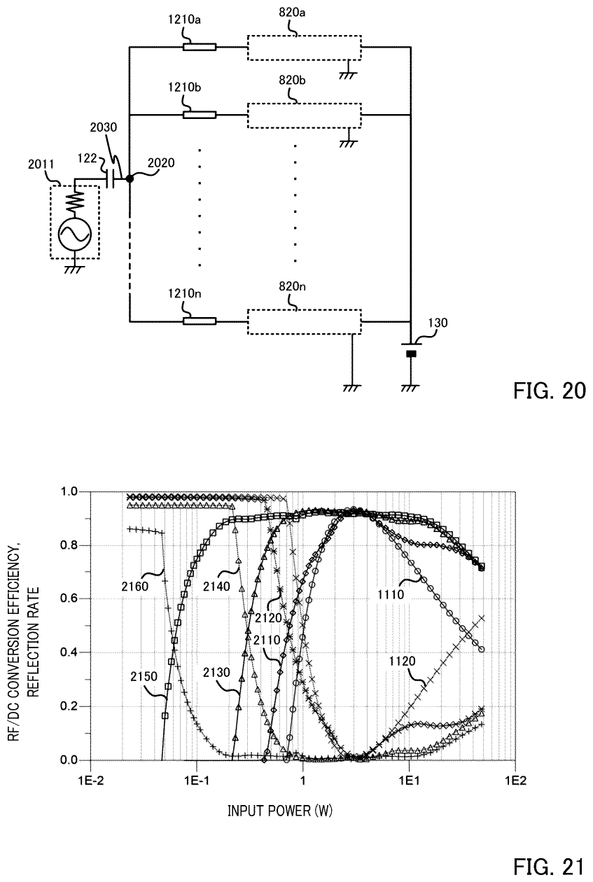

The matching method of dividing three or more lines can be applied to a rectenna circuit. FIG. 20 illustrates an example in which a plurality of rectifier circuits 820a to 820n are connected in parallel to branch point 2020, and phase shifters 1210a to 1210n are provided at inputs of the respective rectifier circuits.

Rectifier circuits 820a to 820n in FIG. 20 are the same as 820 in FIG. 8, and the matching circuit and the LPF are not connected. The rectenna circuit to which the matching circuit and the LPF are connected may be used; however, in the optimization of the multi-line, it is possible to provide the LPF function together with the matching circuit and therefore the parts of the matching circuit and the LPF can be omitted, reducing the number of components and the circuit scale.

The optimization function of the circuit simulator is used for determining the phase shift angle in the phase shifter. The optimization function of the circuit simulator may not result in a strict reflection rate of 0 in some cases, but it can set the reflection rate to the required condition or less. On the other hand, the power value for the purpose of reflection suppression is designated in a range, but not a point, and thus the reflection rate can be reduced more uniform as the number of branches increases. On the other hand, since the number of components increases as the branching number increases, and therefore the number of branches is determined in consideration of both factors based on the usage conditions.

Table 3 illustrates relationships of the optimization power range of the case where two lines, four lines, or eight lines are connected, and the phase shift angle of the phase shifter connected to the input of each line.

TABLE 3

| | | Branched | Branched | Branched |
|---|---|---|---|---|
| Number of branches | | into 2 | into 4 | into 8 |
| Optimization power range | | 3 W | 0.8 W to 6 W | 0.2 W to 12 W |
| Phase shift | Line 1 | 41.3 | 15.0 | 0.0 |
| angle (degree) | Line 2 | 87.3 | 37.8 | 15.8 |
| | Line 3 | | 56.7 | 29.5 |
| | Line 4 | | 85.4 | 39.4 |
| | Line 5 | | | 53.2 |
| | Line 6 | | | 64.3 |
| | Line 7 | | | 77.6 |
| | Line 8 | | | 89.7 |
| Line in FIG. 11 | Efficiency | 2110 | 2130 | 2150 |
| | Reflection | 2120 | 2140 | 2160 |
| | rate | | | |

In FIG. 21, line 2110 indicates the RF/DC conversion efficiency in the case of branching into two lines, and line 2120 indicates the reflection rate. Here, optimization was performed such that the reflection at 3 W is zero. When the phase shift angle in each phase shifter in the case of branching into two lines is set to 41.3 degrees and 87.3 degrees, the reflection at 3 W can be suppressed, and even without a matching circuit and LPF, it is possible to obtain an efficiency substantially identical to that of the case of 1110 in FIG. 10, which uses an LPF and a matching circuit.

In FIG. 21, line 2130 indicates the RF/DC conversion efficiency in the case of branching into four lines, and line 2140 indicates the reflection rate. Here, optimization was performed such that the reflection in the range of 0.8 W to 6 W is zero. The phase shift angles in the phase shifters were determined to be 15.0 degrees, 37.8 degrees, 56.7 degrees, and 85.4 degrees.

In FIG. 21, line 2150 indicates the RF/DC conversion efficiency in the case of branching into eight lines, and line 2160 indicates the reflection rate. Here, the optimization was performed such that the reflection rate at 0.2 to 12 W is zero. In the case of branching into eight lines, the phase shift angles in the phase shifters were determined to be 0.0 degrees, 15.8 degrees, 29.5 degrees, 39.4 degrees, 53.2 degrees, 64.3 degrees, 77.6 degrees, and 89.7 degrees.

Since the reflection rate varies depending on the power of the input signal in the rectenna circuit, the received power in each line is not uniform, and the ratio of the power dispersed to each line also varies depending on the power of the input signal. Therefore, it is difficult to determine the individual admittance of each line, which is performed in the case of the antenna.

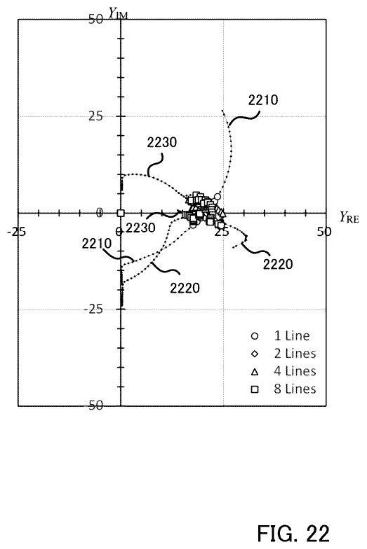

However, it is possible to determine the composite value of the admittance. FIG. 22 illustrates the average admittance per line of each line. In FIG. 22, the dotted line indicates a complex representation of admittance of a case where the input signal of each line changes the power to 0.1 W to 50 W.

In FIG. 21, the white circle, diamond, triangle, or quadrilateral indicate the cases in which the reflection rate is 2% or less. In FIG. 22, line 2210 indicates the composite admittance of the case of one line with a matching circuit, line 2220 indicates the composite admittance of the case of two lines without connecting a matching circuit in the present invention, and line 2230 indicates the composite admittance of the case of four lines in the present invention. The case of the eight lines is not indicated because the reflection rate is almost entirely 2% or less within this power range, and is hidden behind the symbols of other lines.

In each case, the average admittance per line for each line indicates that the real part is approximately 20 mS and the imaginary part is zero. Even when the real part of the composite admittance as viewed from the branch point is exactly 1/Z_{c} and the imaginary part is not exactly 0 with respect to the characteristic impedance Z_{c} of the input transmission line and the signal source, the reflection rate is often sufficiently low and is not a problem in practice.

In order to suppress reflection, it is necessary to adjust two parameters for one input condition, and as such increasing the number of lines can achieve more accurate adjustments, but increase the cost. Therefore, the number of divisions is determined by the balance between the strictness of the condition in the range to be controlled and the increase in cost due to the number of divisions.

### Embodiment 7: Phase Shifter in Low-Frequency Domain

In Embodiment 2 to Embodiment 6, the frequency of the input signal is a microwave of 2.45 GHz or 5.8 GHz, and an LPF, a matching circuit, and an impedance line are used as the phase shifter. However, when the frequency of the input signal is low, an LC circuit is used as the phase shifter.

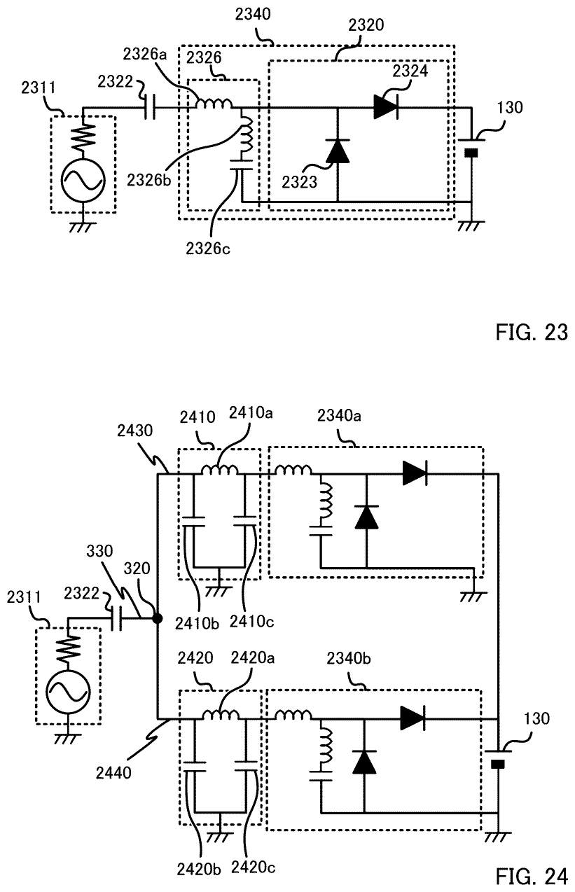

FIG. 23 illustrates a rectenna circuit using a phase shifter as an LC circuit for an input signal with a frequency of 13.56 MHz. The diode is a commercially available silicon Schottky barrier diode. Power source 2311 is connected to one side of capacitor 2322. The other side of capacitor 2322 is connected to one side of inductor 2326a. The other side of inductor 2326a is connected to one side of inductor 2326b, the cathode of SBD 2323, and the anode of SBD 2324. The other side of inductor 2326b is connected to one capacitor 2326c. The other side of capacitor 2326c is connected to ground.

The anode of SBD 2323 is connected to ground. The cathode of SBD 2324 is connected to load 130.

Inductor 2326a, inductor 2326b, and capacitor 2326c make up LPF and matching circuit 2326. SBD 2323, SBD 2324, and capacitor 2325 make up rectifier circuit 2320. Rectifier circuit 2320, the LPF, and matching circuit 2326 make up rectenna circuit 2340.

Here, when load 130 is a constant-voltage load of 100V, the inductance of inductor 2326a is 828 nH, the inductance of inductor 2326b is 177 nH, and the capacitance of capacitor 2326c is 86.6 pF, matching is achieved for the input power of 10 W and no reflection occurs in rectenna circuit 2340.

FIG. 24 is a diagram illustrating a circuit in which the two circuits in FIG. 23 are connected in parallel.

Input transmission line 330 to which power source 2311 is connected branches at branch point 320 into first line 2430 and second line 2440.

First line 2430 includes phase shifter 2410, and second line 2440 includes phase shifter 2420. With these phase shifters, matching can be achieved also for an input power of 30 W in addition to input power of 10 W with a single line. The output power of power source 2311 is twice the power input to each line. In order to achieve matching for the input power of 30 W, it suffices to set the phase shift angle of phase shifter 2410 to 97.7 degrees, and the phase shift angle of phase shifter 2420 to 155.1 degrees according to simulation using a transmission line. In view of this, the inductance of inductor 2410a is set to 582 nH, the capacitances of capacitor 2410b and capacitor 2410c are set to 269 pF, the inductance of inductor 2420a is set to 247 nH, and the capacitances of capacitor 2420b and capacitor 2420c are set to 1063 pF. In this manner, for phase shifters 2410 and 2420, it is possible to realize the desired phase shift angle with the input/output impedance of 50Ω.

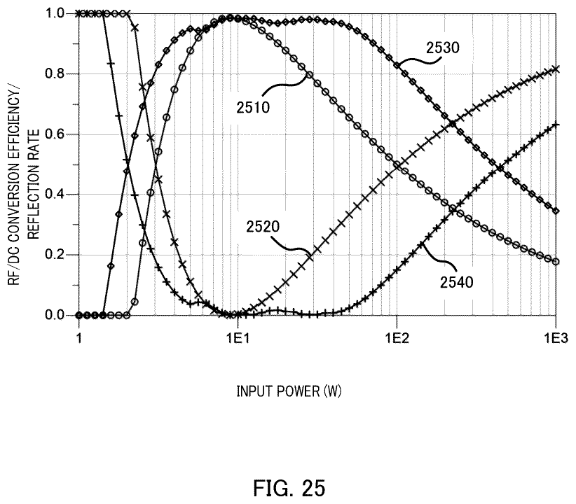

FIG. 25 is a diagram illustrating the reflection rate and the RF/DC conversion efficiency in the cases where the input power is varied in the circuit of FIG. 23 and the circuit of FIG. 24.

Line 2510 indicates the RF/DC conversion efficiency of the circuit in the single line in FIG. 23, and line 2520 indicates the reflection rate of the circuit in the single line in FIG. 23. Line 2530 indicates the RF/DC conversion efficiency of the circuit in FIG. 24, and line 2540 indicates the reflection rate of the circuit in FIG. 24.

It can be understood from FIG. 25 that the multi-line circuit in FIG. 24 maintains high efficiency over a wider input power range than the single-line circuit in FIG. 23.

In Embodiments 2 to 7, the circuit of the rectifier circuit (an alternating current circuit) connected to each line has the same characteristics, but the characteristics may not be the same. Even with a circuit having different characteristics can suppress the reflection by setting the phase shift amount of each line such that the imaginary part of the impedance of each line has the same absolute value with the opposite sign, and that the real part of the composite impedance is equal to the real part of the impedance before branching. This has already been described in Embodiment 1.

### Effects

As described above, according to the present disclosure, it is possible to prevent the reflection of high-frequency signals in alternating current equipment for a plurality of different input signals with a branch into a plurality of lines and a phase shifter provided to each line. In an antenna, it is possible to emit radio waves at different frequencies and over a wider bandwidth. Since the input impedance of the rectenna varies with the input power, the present disclosure makes it possible to prevent reflection over a wider range of input power and to achieve high efficiency. It can be combined with a known matching circuit, and in that case reflection suppression over a wider range can be achieved.

According to the present disclosure, the reflection rate can be reduced in a wider power range in the rectenna circuit. Further, radio waves can be efficiently emitted at multiple frequencies in the antenna.

The phase shifter may be an impedance line or an LC circuit. Further, the frequency of the input signal can correspond to a wide frequency range from kHz to GHz.

Although the examples of the present disclosure have been described in detail above, the present disclosure is not limited to the specific embodiments described above, and various variations and changes are possible within the scope of the gist of the present disclosure as set out in the claims.
(1) An alternating current apparatus according to an aspect of the present invention includes: a transmission line of an output impedance Z_{C} with one end point connected to an alternating current power source; a plurality of phase shifters connected to the other end point of the transmission line; and an alternating current circuit connected to each of the plurality of phase shifters. Each of the plurality of phase shifters has a phase shift angle and a characteristic impedance with which a real part of a composite admittance as viewed from the other end point is 1/Z_{C} and an imaginary part is zero for a plurality of conditions of an input signal.
(2) In the alternating current apparatus to an aspect of the present invention, the alternating current circuit connected to each of the plurality of phase shifters is an antenna.
(3) In the alternating current apparatus to an aspect of the present invention, the alternating current circuit connected to each of the plurality of phase shifters is a rectifier circuit.

This application is entitled to and claims the benefit of Japanese Patent Application No. 2023-181151 filed on Oct. 20, 2023, the disclosure each of which including the specification, drawings and abstract is incorporated herein by reference in its entirety.

### INDUSTRIAL APPLICABILITY

By applying the present disclosure to a rectenna circuit, it is possible to eliminate waste of power by realizing high conversion efficiency even in the case where the input power largely changes in non-contact power supply.

### REFERENCE SIGNS LIST

111, 1211, 1411, 1711, 1811, 2011, 2311 Power source
112 Oscillator
113 Power resistor
120, 820, 2320 Rectifier circuit
122, 2322 Direct current cut capacitor
612, 2326c Matching Circuit Capacitor
2410b, 2420b phase shifter capacitor
611, 2326a, 2326b Matching circuit inductor
2410a, 2420a Phase shifter inductor
123, 124, 823, 824, 2323, 2324 Diode
130 Load
220, 1020, 2340 Rectenna circuit
226, 610, 1026, 2326 Matching circuit
227, 927 Harmonics cutoff filter (LPF)
310 Input terminal
320, 1730, 1820, 2020 Branch point
330, 1740, 1830, 2030 Input transmission line
340, 350 Alternating current circuit
710, 720, 1210, 1220, 1410, 1420, 1710, 1720, 2410, 2420 Phase shifter
730, 740, 1230, 1240, 2430, 2440 Line
1430, 1440 Antenna

1. An alternating current apparatus, comprising:
a transmission line of an output impedance Z_{C} with one end point connected to an alternating current power source;
a plurality of phase shifters connected to the other end point of the transmission line; and
an alternating current circuit connected to each of the plurality of phase shifters,
wherein each of the plurality of phase shifters has a phase shift angle and a characteristic impedance with which a real part of a composite admittance as viewed from the other end point is 1/Z_{C} and an imaginary part is zero for a plurality of conditions of an input signal.

2. The alternating current apparatus according to claim 1, wherein the alternating current circuit connected to each of the plurality of phase shifters is an antenna.

3. The alternating current apparatus according to claim 1, wherein the alternating current circuit connected to each of the plurality of phase shifters is a rectifier circuit.
